(19) United States
(12) Patent Application Publication
(10) Pub. No.: US 2001/0007890 A1
(43) Pub. Date: Jul. 12, 2001

(54) Preparation of stabilized styrene polymers

(76) Inventors: Norbert NieSsner, Friedelsheim (DE); Peter Barghoorn, Kallstadt (DE); Axel Gottschalk, Neustadt (DE); Wolfgang Fischer, Walldorf (DE); Zafirios Grammatis, Laumersheim (DE)

Correspondence Address: Messrs. Keil & Weinkauf, 1101 Connecticut Ave., N.W., Washington, DC, 20036, US

(21) Appl. No.: 09/726,044

(22) Filed: Nov. 30, 2000

(30) Foreign Application Priority Data
Dec. 2, 1999 (DE) 19958024.3

(51) Int. Cl. C08K 5/13; C08J 3/00; C08L 25/12; C08K 5/49

(52) U.S. Cl. 524/736; 524/710

(57) ABSTRACT

Stabilized styrene polymers comprising one or more vinylaromatic monomers, one or more comonomers and one or more antioxidants are prepared by polymerizing the monomers continuously and adding the antioxidants during the continuous polymerization.

The present invention relates to a process for preparing stabilized styrene copolymers comprising one or more vinylaromatic monomers, one or more comonomers and one or more antioxidants.

The invention further relates to the stabilized styrene copolymers obtainable by this process, the use of these for producing moldings, films, fibers or foams, and finally to moldings, films, fibers or foams made from the stabilized styrene copolymers.

It has been known for a long time that styrene copolymers, such as SAN (styrene-acrylonitrile copolymer), ABS (acrylonitrile-butadiene-styrene copolymer, e.g. made of SAN matrix and, dispersed therein, particulate polybutadiene rubber grafted with SAN) or HIBS (high impact polystyrene, comprising polybutadiene rubber) become yellow as they age. This “aging” is exacerbated by high temperatures and UV radiation. This yellowing on aging is also an undesirable alteration of the original shade of the polymeric molding composition. In particular when processing the molding compositions to give moldings, these phenomena of aging on exposure to heat (known as heat-aging) are disruptive, since the intrinsic color of the molding depends on the processing temperatures, e.g. in the extruder or in the injection molding machine: the higher the melt temperature during injection molding, the yellower is the molding in many instances.

To prevent heat-aging, or at least slow its progress, antioxidants (heat stabilizers) are usually added to the polymers. They are mixed into the finished polymer or applied to the surface of the pellets. Although this delays heat-aging, in many instances it gives the polymers an undesirable yellowish intrinsic color (yellow tinge), and even directly after their preparation the polymers are therefore slightly yellowish. The yellowish intrinsic color has either to be compensated (shaded) with a blue dye (in the case of transparent, colorless SAN) or (in the case of pigmented SAN and for ABS) covered by using relatively large amounts of colorants. The yellow tinge makes precise color-matching more difficult and makes the product more expensive, since colorants are comparatively expensive and an additional step is required in the preparation process.

DE-A 1534526 discloses the stabilization of polymers, including ABS, by (4-hydroxy-3,5-dialkylbenzyl)carboxylic esters, and also by the esters mentioned and trisnonylphenyl phosphite. The stabilizers are mixed with the finished polymers.

DE-A 2444671 discloses the stabilization of rubber-reinforced thermoplastic polymers, including ABS and HIPS, by antioxidants selected from the group consisting of phenols, amines, phosphites and esters, and a metal oxide. Antioxidant and metal oxide are added to the finished thermoplastic polymer prepared beforehand by batchwise polymerization.

JP-A2 0414697 (Abstract ACS, AN 117:193127) discloses the preparation of stabilized SAN by polymerizing to 65% conversion, terminating the polymerization, adding the antioxidant Irganox®1076 to the finished polymer and removing the unreacted monomers.

Panov et al., in Plast. Massy (1974), (3), 8-10 (Abstract ACS, AN 81:37880), disclose the preparation of stabilized SAN by polymerizing the monomers in the presence of phenolic and organophosphorus antioxidants. The polymerization is carried out batchwise.

SU-A 429070 (Abstract Derwent AN 37039W/22) discloses the preparation of stabilized SAN by polymerizing the monomers in the presence of phenolic and phosphoric-ester antioxidants, and here, too, the polymerization is carried out batchwise.

DE-C2 2702661 discloses stabilizer systems for polymers, including SAN and ABS, comprising a triaryl phosphite and phenolic antioxidants. The stabilizer systems are added by dry-mixing with the finished polymer, followed by melting, or by applying the stabilizer system to the finished polymer, or by adding the stabilizer system to a solution of the finished polymer.

It is an object of the present invention to overcome the disadvantages described. In particular, the process provided should be capable of preparing stabilized styrene copolymers which firstly have a low level of intrinsic color (a low level of yellow tinge) directly after they have been prepared and secondly give only little yellowing even on prolonged aging, in particular heat-aging. The process should therefore ensure a low level of intrinsic color together with a low level of yellowing on heat-aging. The process should moreover not impair the advantageous mechanical and surface properties of the styrene polymers. A further object is to provide a process which gives molding compositions whose intrinsic color has relatively little dependency on the processing temperatures during the production of moldings. Finally, the stabilizers added, which usually act as free-radical scavengers, should not affect the kinetics of the polymerization reaction, so that when comparison is made with unstabilized polymers there should be no substantial difference in the molar mass of the polymer (measurable indirectly in the form of the melt flow rate MVR) or in the conversion.

We have found that this object is achieved by the process defined at the outset. It has the characterizing feature that the polymerization of the monomers is carried out continuously and that the antioxidants are added during the continuous polymerization.

The stabilized styrene copolymers obtainable by this process have also been found, as has the use of these for producing moldings, films, fibers or foams, and, finally, the moldings, films, fibers and foams made from the stabilized styrene copolymers.

In contrast with the prior art, the novel process is carried out continuously (rather than batchwise) and the antioxidants are added before the polymerization of the monomers ends (rather than after the polymerization to give the finished polymer has ended).

Possible vinylaromatic monomers suitable for the novel process are styrene and styrene derivatives of the formula I:

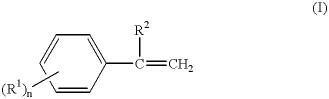

where

R¹ and R², independently of one another, are H or C₁-C₈-alkyl and

n is 0, 1, 2 or 3.

It is preferable to use styrene, α-methylstyrene, p-methylstyrene, tert-butylstyrene or a mixture of these, and styrene is particularly preferably used.

The following monomers are possible comonomers which are copolymerized with the vinylaromatic monomers:

monoethylenically unsaturated nitrile compounds, e.g. acrylonitrile, methacrylonitrile or a mixture of these, preferably acrylonitrile;

C₁-C₄-alkyl methacrylate, such as methyl methacrylate, and also the glycidyl esters glycidyl acrylate and glycidyl methacrylate;

N-substituted maleimides, such as N-methyl-, N-phenyl- and N-cyclohexylmaleimide;

acrylic acid, methacrylic acid, and also dicarboxylic acids, such as maleic acid, fumaric acid and itaconic acid, and also anhydrides of these, such as maleic anhydride;

nitrogen-functional monomers, such as dimethylaminoethyl acrylate, diethylaminoethyl acrylate, vinylimidazole, vinylpyrrolidone, vinylcaprolactam, vinylcarbazole, vinylaniline, acrylamide and methacrylamide;

aromatic or araliphatic esters of acrylic or methacrylic acid, such as phenyl acrylate, phenyl methacrylate, benzyl acrylate, benzyl methacrylate, 2-phenylethyl acrylate, 2-phenylethyl methacrylate, 2-phenoxyethyl acrylate and 2-phenoxyethyl methacrylate;

unsaturated ethers, such as vinyl methyl ether,

and also mixtures of these monomers.

Preference is given to acrylonitrile and maleic anhydride.

Other suitable comonomers are:

dienes with conjugated double bonds, such as butadiene, isoprene, norbornene, and halo-substituted derivatives of these, such as chloroprene. Preference is given to butadiene and isoprene, in particular butadiene;

C₁-C₁₀-alkyl acrylates, such as ethyl acrylate, 2-ethylhexyl acrylate and n-butyl acrylate, preferably 2-ethylhexyl acrylate and n-butyl acrylate, very particularly preferably n-butyl acrylate. It is also possible to use mixtures of alkyl acrylates which have different alkyl radicals.

It is, of course, also possible to use mixtures comprising vinylaromatic monomers and at least two other different comonomers from one or more of the groups mentioned.

If the styrene copolymers obtained according to the invention are blended with elastomeric polymers the products are impact-modified molding compositions. Suitable elastomeric polymers have a glass transition temperature (determined by differential scanning calorimetry) below 0° C. Examples of these are polybutadiene rubbers, polybutylacrylate rubbers and polyethylene-propylene(-diene) rubbers. The impact-modified molding compositions are known to the skilled worker as HIPS, ABS, ASA (acrylonitrile-styrene-acrylate copolymer) and AES (acrylonitrile-ethylene-propylene (-diene) copolymer). HIPS and ABS were described at the outset.

The ABS blends and ASA blends are preferably graft copolymers. They comprise a hard matrix which essentially comprises SAN, and also a particulate graft rubber dispersed in the matrix. In the case of ABS the rubber comprises a core based on polybutadiene, grafted with an SAN shell, while in the case of ASA the core is based on crosslinked polyalkyl acrylate (in particular polybutyl acrylate), grafted with an SAN shell. The structure of the SAN shell may have one or more stages. For example, the shell may have a first (inner) stage made of styrene homopolymer and a second (outer) stage made of styrene-acrylonitrile copolymer. The transition here between the stages may be sharp or tapered (=gradual). The structure of the core may also have one or more stages. In particular it may have an inner stage made of styrene homo- or copolymer and an outer stage made of polybutadiene (in the case of ABS) and, respectively, polyalkyl acrylate (in the case of ASA).

According to the invention, the styrene copolymers are prepared continuously.

The novel continuous process may be carried out in various ways, e.g. in emulsion, in microemulsion, in miniemulsion, in suspension, in microsuspension, in minisuspension, as a precipitation polymerization, and in particular in bulk or in solution.

In the case of the bulk polymerization, the monomers are polymerized without adding any reaction medium, using monomer-soluble initiators, and the monomers are therefore the reaction medium. It is equally possible to use thermal initiation.

Solution polymerization differs from bulk polymerization mainly in the concomitant use of an organic solvent, such as cyclohexane, ethylbenzene or dimethyl sulfoxide, to dilute the monomers. Monomer-soluble initiators or thermal initiation may be used.

Initiators which are suitable are those with marked solubility in the monomers but poor solubility in water.

The initiators RI used therefore comprise organic peroxides, organic hydroperoxides, azo compounds and/or compounds having C—C single bonds. Monomers which polymerize spontaneously at an elevated temperature are also used as free-radical polymerization initiators. It is also possible to use mixtures of the initiators RI mentioned. In the case of the peroxides, preference is given to those with hydrophobic properties.

Preferred azo compounds are 2,2′-azobis(2-methylbutyronitrile) and 2,2′-azobis(isobutyronitrile). Preferred compounds having labile C-C bonds are 3,4-dimethyl-3,4-diphenylhexane and 2,3-dimethyl-2,3-diphenylbutane.

The novel process may also be carried out as a combined process in which at least two of the abovementioned polymerization processes are combined with one another. Mention should be made here in particular of bulk/solution, bulk/suspension and bulk/emulsion, where the process begins with the first-named and ends with the last-named method.

In emulsion polymerization and its variants (microemulsion, miniemulsion) the monomers are emulsified in water, with concomitant use of emulsifiers. The emulsifiers suitable for stabilizing the emulsion are soap-like auxiliaries which encapsulate the monomer droplets and thus prevent coalescence of the same.

Suitable emulsifiers are the anionic, cationic and neutral (non-ionogenic) emulsifiers known to the skilled worker. Examples of anionic emulsifiers are alkali metal salts of higher fatty acids having from 10 to 30 carbon atoms, such as palmitic, stearic and oleic acid, alkali metal salts of sulfonic acids having, for example, from 10 to 16 carbon atoms, in particular sodium salts of alkyl- or alkylarylsulfonic acids, alkali metal salts of half-esters of phthalic acid, and alkali metal salts of resin acids, such as abietic acid. Examples of cationic emulsifiers are salts of long-chain, in particular unsaturated, amines having from 12 to 18 carbon atoms, and quaternary ammonium compounds with relatively long-chain olefin or paraffin radicals (i.e. salts of quaternized fatty amines). Examples of neutral emulsifiers are ethoxylated fatty alcohols, ethoxylated fatty acids and ethoxylated phenols, and fatty acid esters of polyhydric alcohols, such as pentaerythritol or sorbitol.

Initiators preferably used for emulsion polymerization are those with poor solubility in the monomer but good solubility in water. Preference is therefore given to the use of peroxosulfates, such as potassium, sodium or ammonium peroxodisulfate, or else of redox systems, in particular those based on hydroperoxides, such as cumene peroxide, or dicumyl peroxide.

Other additives which may be used during the polymerization are buffers, such as Na₂HPO₄/NaH₂PO₄ or Na citrate/citric acid, these being substances intended to set and retain an essentially constant pH. Concomitant use may also be made of molecular weight regulators, for example mercaptans, such as tert-dodecyl mercaptan, or ethylhexyl thioglycolate.

In suspension polymerization and its variants (microsuspension, minisuspension) the monomers are suspended in water with concomitant use of protective colloids.

Suitable protective colloids are cellulose derivatives, such as carboxymethylcellulose and hydroxymethylcellulose, poly-N-vinylpyrrolidone, polyvinyl alcohol and polyethylene oxide, anionic polymers, such as polyacrylic acid and its copolymers, and cationic polymers, such as poly-N-vinylimidazole. The amount of these protective colloids is preferably from 0.1 to 5% by weight, based on the total weight of the emulsion. Protective colloids, and also processes for preparing protective colloids, are known per se and are described, for example, in Encyclopedia of Polymer Science and Engineering, Vol. 16, p. 448, Verlag John Wiley, 1989.

The amount of free-radical initiator is preferably from 10⁻⁶ to 5 mol/l, in particular from 10⁻⁴ to 10⁻¹ mol/l, based on the monomers. The precise amount depends in a known manner on the desired molecular weight of the polymer. The amounts given here do not of course relate to the case where a monomer is at the same time an initiator and thermal initiation is used, as is possible with styrene, for example.

The novel process is preferably a solution or bulk polymerization or a combined bulk/solution polymerization, particularly preferably a solution polymerization.

Further details of the polymerization processes mentioned may be found by the skilled worker in “Ullmann's Encyclopedia of Industrial Chemistry”, 5^{th} edn., Vol. A21, ed. Elvers et al., VCH Verlag, Weinheim 1992, in particular Section 3.3.3=pp. 355-393.

Specific details of the polymerization of styrene copolymers can be found by the skilled worker in “Handbuch der Technischen Polymerchemie” by A. Echte, VCH Verlag, Weinheim 1993, in particular Section 8.3=pp. 475-492, for example.

Suitable types of reactor are those which permit continuous operation, i.e. any embodiment of the continuous stirred tank reactor (through-flow reactor or CSTR) and any embodiment of the flow tube (through-flow tube or continuous flow reactor, CFR). Examples of such embodiments are

tubular reactor with or without provision for further addition of monomers and/or initiators

extruder reactor

tower reactor

continuous stirred tank reactor

fluidized-bed (gas-phase) reactor

loop or double-loop reactor

stirred tank reactor cascade

stirred tank/tower reactor combination

tower cascade

rotating disk reactor.

Details of reactors can be found by the skilled worker in the abovementioned book by A. Echte on pp. 351-413 in Chapter 7.

Preferred reactors are the tower and continuous stirred tank and stirred tank cascade reactors.

According to the invention, antioxidants are added during the continuous polymerization. Suitable antioxidants are any of the antioxidants known to the skilled worker. They are described by way of example in “Plastics Additives”, ed. R. Gächter and H. Müller, 4^{th} edn., Hanser Verlag 1993, Reprint November 1996, in particular Section 1=pp. 1-104.

Particularly suitable antioxidants are those selected from the group consisting of the following classes of compounds 1) to 11). The structures given for the classes of compounds are typical representatives of each class by way of example.

[chemical structure]

inorganic phosphites and inorganic hypophosphites, e.g. metal salts of phosphorous acid H₃PO₃ and, respectively, of? hypophosphorous acid H₃PO₂, in particular alkali metal (10-7) phosphites, alkaline earth metal phosphites, alkali metal hypophosphites and alkaline earth metal hypophosphites, for example calcium phosphite CaHPO₃, sodium hypophosphite NaH₂PO₂ and potassium hypophosphite KH₂PO₂

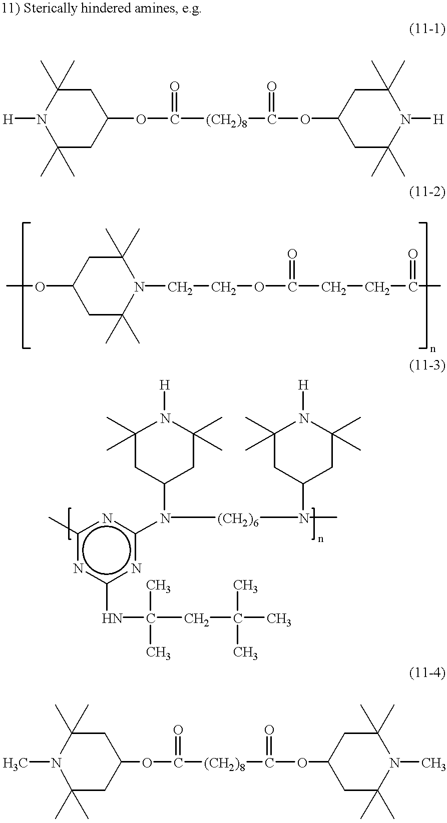

The sterically hindered amines (No. 11) are also termed HALS (hindered amine light stabilizers).

Preferred antioxidants are

a) sterically hindered phenols, in particular the compounds of classes 1, 2, 3, 4, 6 and 7 and compound 8-3 in the above list,

b) phosphites and phosphonites, in particular the compounds in class 10 of the above list, and

c) mixtures of these.

Particularly preferred antioxidants are

aa) sterically hindered phenols which contain an ester group, in particular the compounds in class 2 and the compound 4-3 in the above list,

bb) triaryl phosphites and triaryl phosphonites, in particular the compounds 10-1, 10-2, 10-3 and 10-6 in the above list, and

cc) mixtures of these.

Very particular preference is given to the mixtures cc).

Preferred mixtures cc) comprise in each case at least one antioxidant from each of the two groups aaa) and bbb) below:

aaa)

compound 2-1,

compound 2-2,

bbb)

compound 10-1,

compound 10-3,

compound 10-6.

Particularly preferred mixtures cc) comprise compound 2-1 and compound 10-1.

All of the antioxidants mentioned are known and obtainable commercially, for example from the companies named in the abovementioned book by Gächter and Müller, on pp. 96-99 in Section 1.10.

The amount of the antioxidants is from 0.005 to 5% by weight, preferably from 0.03 to 3% by weight and particularly preferably from 0.05 to 1% by weight, based on the total amount of the monomers used. The abovementioned amounts are the total amount of all of the antioxidants in cases where more than one antioxidant is used.

According to the invention, the antioxidants are added during the continuous polymerization of the monomers. The antioxidants may be introduced to the polymerization reactor at one point or at two or more points. The precise method of addition depends in particular on the reactor used. For example, the antioxidants may be introduced to the reactor together with a monomer, together with a mixture made of two or more monomers, or separately from the monomers.

In addition to the antioxidants, use may be made of light stabilizers (UV stabilizers) in order to increase the UV-stability of the polymers prepared by the novel process. Suitable light stabilizers are any of those known to the skilled worker. They are mentioned by way of example in the abovementioned book “Plastics Additives” by Gächter and Müller, on pp. 129-270 in Section 3.

Particularly suitable light stabilizers are those selected from the group consisting of the following classes of compounds I) to VII). The structures given for the classes of compounds are typical representatives of each class by way of example.

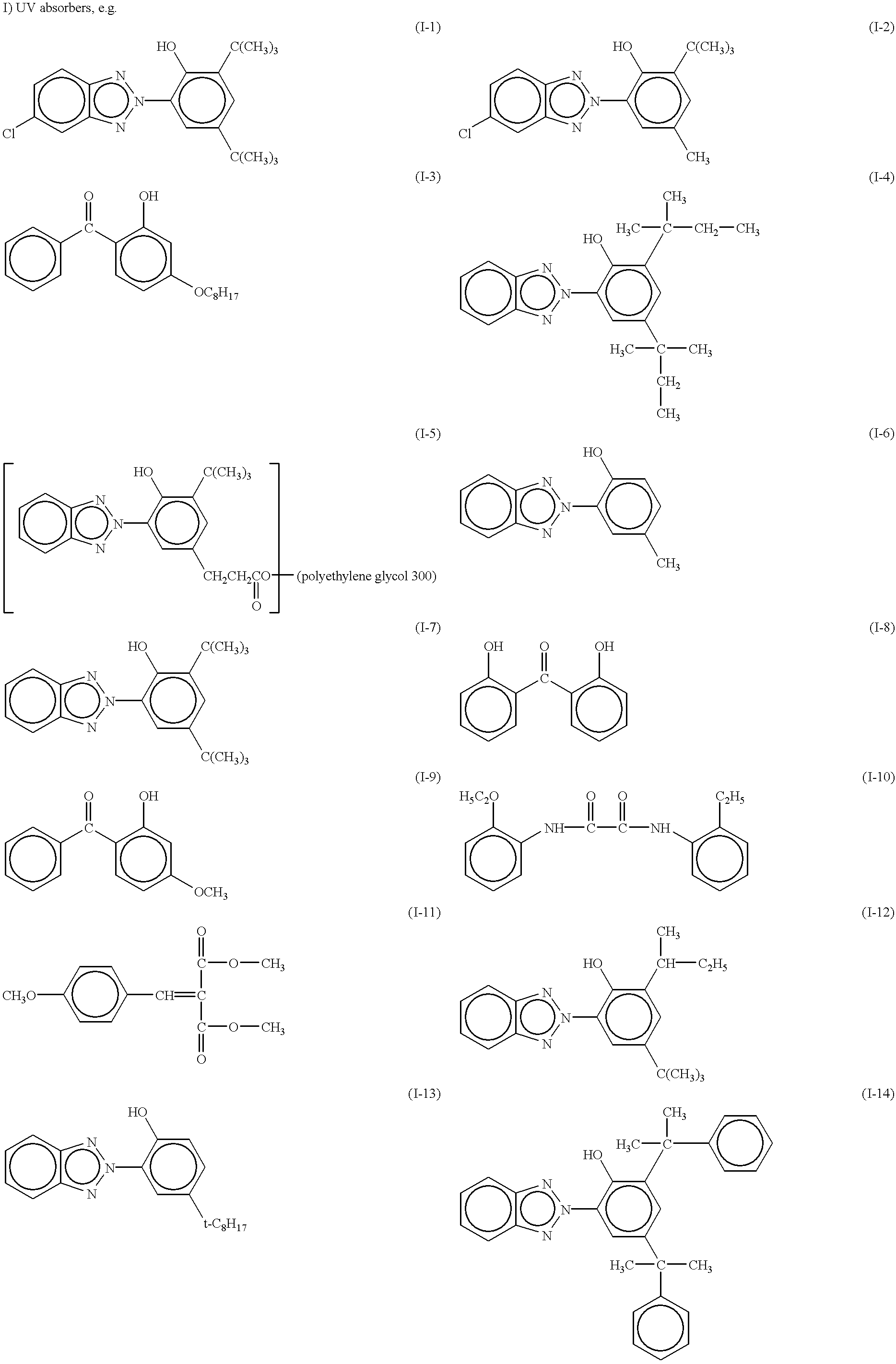

Preferred light stabilizers used are

benzotriazoles, in particular compounds I-1, I-2, I-4, I-5, I-6, I-7, I-12, I-13 and I-14, in the above list,

sterically hindered amines, in particular the compounds of class 2 in the above list, and

mixtures of these.

Particular preference is given to mixtures made of benzotriazoles with sterically hindered amines (also termed HALS).

All of the light stabilizers mentioned are known and commercially available, for example from the companies named in the abovementioned book by Gächter and Müller, on pp. 260-262 in Section 3.6.

The amount used of the light stabilizers is from 0.01 to 5% by weight, preferably from 0.2 to 3% by weight and particularly preferably from 0.4 to 1.5% by weight, based on the polymer. In cases where more than one light stabilizer is used, the abovementioned amounts are the total amount.

The light stabilizers may be introduced during the polymerization of the monomers and/or into the finished polymer. If they are introduced during the polymerization, the addition may take place in a manner identical to that described above for the antioxidants.

Addition to the finished polymer takes place in the usual manner by “cold” mixing of the finished polymer with the light stabilizers if, for example, the light stabilizers are powders or pellets. It is also possible to wet the finished polymer pellets with a solution of the light stabilizer, giving—after removal of the solvent, where appropriate—pellets coated with a surface layer of the light stabilizers. It is also possible for the light stabilizers to be added into the mixing equipment (kneader, roll mill, calender, extruder or other equipment) during the further processing of the polymer to give polymer blends. The light stabilizers may also be added to the equipment used to produce moldings (injection molding machine, extruder for profiles, sheets, fibers or films, or other equipment) during the processing of the polymer to give the moldings. Combinations of the addition methods mentioned are also possible.

The styrene copolymers obtainable by the novel process may be used as such or blended with other polymers and/or with additives.

These other polymers are in particular thermoplastic polymers, and include polyesters, such as polyethylene terephthalate and polybutylene terephthalate, polycarbonates, polyamides, polyoxymethylene, polystyrene, polyolefins, such as polyethylene and polypropylene, polyvinyl chloride, and styrene copolymers, such as styrene-acrylonitrile copolymer.

The amount of the other polymers is usually from 0 to 99% by weight, preferably from 0 to 90% by weight, based on the total of styrene copolymers and other polymers.

Possible additives are the usual additives, e.g. lubricants, mold-release agents, pigments, dyes, flame retardants, fibrous or pulverulent fillers, fibrous or pulverulent reinforcing agents, antistats, and also other additives or mixtures of these.

Examples of suitable lubricants and mold-release agents are fatty acids, such as stearic acids, stearyl alcohol, fatty acid esters having from 6 to 20 carbon atoms, e.g. stearates, metal salts of the fatty acids, such as the stearates of Ca, Al or Zn, fatty amides, such as stearamides, and also silicone oils, montan waxes, and those based on polyethylene and polypropylene, and also hydrocarbon oils, paraffins, and the carboxylic esters made from long-chain carboxylic acids and from ethanol, fatty alcohols, glycerol, ethanediol or pentaerythritol, or from other alcohols.

Examples of pigments are titanium dioxide, phthalocyanines, ultramarine blue, iron oxides and carbon black, and also the organic pigments.

For the purposes of the present invention, dyes are any dye which can be used for transparent, semitransparent or non-transparent coloration of polymers, in particular those suitable for coloring styrene copolymers. Dyes of this type are known to the skilled worker.

Examples of flame retardants which may be used are the halogen- phosphorus-containing compounds known to the skilled worker, magnesium hydroxide, and also other commonly used compounds, and mixtures of these.

Examples of fibrous or pulverulent fillers are carbon fibers or glass fibers in the form of glass fabrics, glass mats or glass filament rovings, chopped glass, glass beads, and also wollastonite, particularly preferably glass fibers. When glass fibers are used, these may have been provided with a size and with a coupling agent, to improve compatibility with the blend components. The glass fibers may be incorporated either as short glass fibers or else as continuous-filament strands (rovings).

Suitable particulate fillers are carbon black, amorphous silica, magnesium carbonate, chalk, powdered quartz, mica, bentonite, talc, feldspar and in particular calcium silicates, such as wollastonite, and kaolin.

Examples of suitable antistats are amine derivatives, such as N,N-bis(hydroxyalkyl)alkylamines or -alkyleneamines, polyethylene glycol esters and glycerol mono- and distearates, and also mixtures of these, and polyethers.

The usual amount of each additive is used. The amount usually used of the additives is from 0 to 50% by weight, based on the total of styrene copolymers and additives.

The blending of the styrene copolymers with the other polymers and/or with the additives takes place continuously or batchwise by mixing processes known per se, for example with melting in an extruder, Banbury mixer or kneader, or on a roll mill or calender. However, the components may also be mixed “cold” and the mixture not melted or homogenized until it is processed. The mixing usually takes place at from 130 to 350° C., preferably from 160 to 280° C., in particular from 190 to 240° C.

The blending preferably takes place in a customary extruder. The components here may, for example, be fed individually or as a mixture to the extruder entirely via a hopper, or else a proportion of the components may be fed at a downstream point of the extruder into the molten or solid product within the extruder. The resultant mixtures may be pelletized or granulated, for example, or processed by well known processes, such as extrusion, injection molding, foaming with blowing agents or calendering.

It is surprising that addition of the antioxidants has no substantial effect on the kinetics of the polymerization reaction. Compared with a product prepared without addition of antioxidant, the conversion and the molar mass of the polymer (molar mass measurable indirectly as melt flow rate MVR) do not alter significantly.

The novel process gives styrene copolymer molding compositions which have a low level of intrinsic color and which give little yellowing even on prolonged aging, in particular heat-aging, while the advantageous mechanical properties and surface properties of the styrene copolymer molding compositions are retained.

The molding compositions may be processed to give moldings of any type, or to give semifinished products, such as extrudates, or else to give films, fibers or foams. The styrene copolymer molding compositions may be used in particular to produce lamp housings and lamp covers, in particular for elongated lighting systems or for the rear lamps of motor vehicles.

The moldings produced from the molding compositions show only low dependency of their intrinsic color on processing temperatures, e.g. on the melt temperature in the injection molding machine.

### EXAMPLES

The following antioxidants were used:

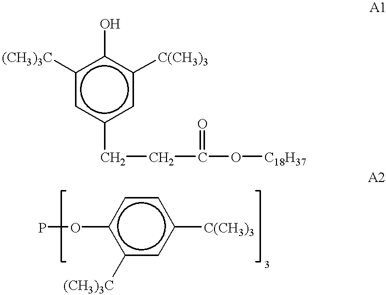

The amount of the antioxidants is given in % by weight and is based on the total amount of the monomers used.

### Comparative Examples 1 and 2

### Batchwise Polymerization (Solution Polymerization)

A mixture made of

1.947 kg of styrene,

0.684 kg of acrylonitrile, and

0.369 kg of ethylbenzene,

and the stabilizers given in Table 1 formed an initial charge in a 4 l stirred tank reactor designed for batch operation, which had been flushed with nitrogen. The mixture was heated to 144° C. and polymerized thermally (without addition of initiator) to a conversion of about 60%. Specimens were taken from the reactor contents. A vented extruder was used to free these from unconverted monomers and from solvent.

The resultant pellets were injection molded at various melt temperatures to give specimens of dimensions 50×50×2 mm. The melt temperatures used in the injection molding machine are listed in Table 1.

The Yellowness Index (YI) of the test specimens was determined to ASTM D 1925. The Yellowness Index is a measure of intrinsic yellowness: the higher the YI value, the more yellow is the specimen.

TABLE 1

| | | Yellowness Index YI after injection | | |
|---|---|---|---|---|
| | | molding at²⁾ | | |
| Experiment¹⁾ | Antioxidants | 220° C. | 240° C. | 260° C. |
| 1c | 0.05% A1 + | 4.85 | 5.15 | 8.1 |
| | 0.05% A2 | | | |
| 2c | 0.02% A1 + | 6.7 | 7.2 | 8.15 |
| | 0.08% A2 | | | |

¹⁾c: for comparison
²⁾the melt temperature is given

It can be seen that batchwise operation (not according to the invention) of the polymerization gives a marked increase in intrinsic yellowness as the processing temperatures rise: the YI rises sharply from 220 to 260° C. melt temperature.

### Inventive Example 3 and Comparative Example 4

### Continuous Polymerization (Solution Polymerization)

A mixture made of

44.1% by weight of styrene,

29.9% by weight of acrylonitrile, and

26.0% by weight of ethylbenzene,

and the stabilizers given in Table 2 was polymerized thermally (without addition of initiator) at 145° C. in a 12 l continuous stirred tank reactor (through-flow reactor) which had been flushed with nitrogen, until the solids content was about 50% by weight. Specimens were taken from the reactor contents, and freed from unconverted monomers and from solvent by degassing.

The resultant pellets were injection molded to give test specimens.

Specifically, the intrinsic color was determined in a manner similar to that for the comparative examples at various melt temperatures (see Table 2) by producing test specimens of dimensions 50×50×2 mm and determining the Yellowness Index to ASTM D 1925.

TABLE 2

| | | Yellowness Index YI after injection | | |
|---|---|---|---|---|
| | | molding at²⁾ | | |
| Experiment¹⁾ | Antioxidants | 220° C. | 240° C. | 260° C. |
| 3c | — | 7.0 | 7.2 | 7.5 |
| 4 | 0.07% A1 + | 6.3 | 6.7 | 7.4 |
| | 0.27% A2 | | | |

c: for comparison
²⁾the melt temperature is given

With continuous polymerization and addition of the stabilizers during the polymerization, the level of intrinsic color is markedly lower (lower YI) than without addition of antioxidant (comparing 3c with 4). In particular, the rise in Yellowness Index as melt temperatures rise is markedly less pronounced than in Examples 1c and 2c. The novel process therefore gives molding compositions whose intrinsic color is much less dependent on the processing temperatures than is the case with prior art molding compositions.

To determine heat-aging resistance, specimens of dimensions 40×6×4 mm were produced at 240° C. melt temperature and stored for 32 days at 110° C. The color change was then assessed visually.

The result of visual comparison of the specimens after heat-aging is that the specimens made of molding compositions without antioxidant (composition 3c) are markedly darker than specimens made of molding compositions prepared according to the invention with antioxidants (composition 4). The novel molding compositions therefore give markedly less yellowing caused by heat-aging.

### Inventive Examples 6 to 8 and 11 to 16 and Comparative Examples 5, 9 and 10

### Continuous Polymerization (Solution Polymerization)

A mixture made of

75% by weight of styrene,

18% by weight of acrylonitrile, and

7% by weight of ethylbenzene,

and the stabilizers in Tables 3 and 4 was polymerized thermally (without addition of initiator) at 135° C. in a continuous stirred tank reactor (through-flow reactor) which had been flushed with nitrogen, until the solids content was about 65% by weight. Specimens were taken from the reactor contents, and freed from unconverted monomers and from solvent by degassing.

For Examples 6 to 8 and 5c, the pellets obtained were injection molded at 260° C. melt temperature to give disks of 6 mm thickness and 80 mm diameter. The disks were stored for 30 weeks at 90° C. and the Yellowness Index determined at various intervals to ASTM D 1925.

TABLE 3

| | | Yellowness Index YI after storage at 90° C. | | | | | |
|---|---|---|---|---|---|---|---|
| Experi- | Antioxi- | for . . . hours | | | | | |
| ment¹⁾ | dants | 5 h | 10 h | 15 h | 20 h | 25 h | 30 h |
| 5 c | — | 8.1 | 9.8 | 11.3 | 12.2 | 14.8 | 15.2 |
| 6 | 0.02% A1 + | 7.5 | 8.0 | 8.2 | 8.8 | n.d.²⁾ | 9.2 |
| | 0.08% A2 | | | | | | |
| 7 | 0.04% A1 + | 7.5 | 8.0 | 8.9 | 9.5 | 10.3 | 10.5 |
| | 0.16% A2 | | | | | | |
| 8 | 0.06% A1 + | 7.7 | 9.1 | 10.5 | 10.5 | 11.0 | 11.6 |
| | 0.24% A2 | | | | | | |

¹⁾c: for comparison
²⁾n.d. not determined

The table shows that the increase in the Yellowness Index on heat-aging is substantially slower if antioxidants are added (Experiments 6-8) during the continuous polymerization than with molding compositions without antioxidant (Experiment 5c). The novel process therefore considerably reduces yellowing on heat-aging.

For Examples 10 to 16, 9c and 10c the pellets produced were injection molded at 260° C. melt temperature to give test specimens of dimensions 150×10×4 mm, the modulus of elasticity of which was determined at 23° C. by the tensile strain test to ISO 527.

The melt flow rate MVR was determined on pellets at 220° C. with 10 kg load to DIN 53735/30.

TABLE 4

| | | | Modulus of |
|---|---|---|---|
| | | MVR | elasticity |
| | | (10 kg/220° C.) | (23° C.) |
| Experiment¹⁾ | Antioxidants | [ml/10 min] | [MPa] |
| 9c | — | 8.2 | 3526 |
| 10c | — | 9.4 | 3541 |
| 11 | 0.02% Al + | 8.7 | 3519 |
| | 0.08% A2 | | |
| 12 | 0.02% Al + | 8.7 | n.d.²⁾ |
| | 0.08% A2 | | |
| 13 | 0.04% Al + | 9.1 | 3544 |
| | 0.16% A2 | | |
| 14 | 0.04% Al + | 9.0 | n.d. |
| | 0.16% A2 | | |
| 15 | 0.06% Al + | 8.5 | 3563 |
| | 0.24% A2 | | |
| 16 | 0.06% Al + | 9.3 | n.d. |
| | 0.24% A2 | | |

¹⁾c: for comparison
²⁾n.d. not determined

The table shows that the molar mass of the polymer, measured indirectly as MVR, is not significantly altered by adding the antioxidants (MVR unaltered). It follows from this that—surprisingly—the addition of the antioxidants during the novel process does not have any significant effect on the kinetics of the polymerization reaction.

The table also shows that addition of the antioxidants does not impair the advantageous mechanical properties of the polymers: the modulus of elasticity does not alter significantly.

We claim:

1. A process for preparing stabilized styrene copolymers comprising one or more vinylaromatic monomers, one or more comonomers and one or more antioxidants, which comprises carrying out the polymerization of the monomers continuously and adding the antioxidants during the continuous polymerization.

2. A process as claimed in claim 1, wherein the polymerization carried out is a solution, bulk or combined bulk/solution polymerization.

3. A process as claimed in claim 1, wherein the vinylaromatic monomers used comprise styrene, α-methylstyrene or a mixture of these, and the comonomers used comprise acrylonitrile, methacrylonitrile, maleic anhydride or a mixture of these.

4. A process as claimed in claim 1, wherein the vinylaromatic monomer used comprises styrene and the comonomer used comprises acrylonitrile.

5. A process as claimed in claim 1, wherein the antioxidants used have been selected from the group consisting of the sterically hindered phenols or from the group consisting of the phosphites, hypophosphites and phosphonites, or from both of these groups.

6. A process as claimed in claim 1, wherein the antioxidants used comprise in each case at least one from each of the two groups a) and b)

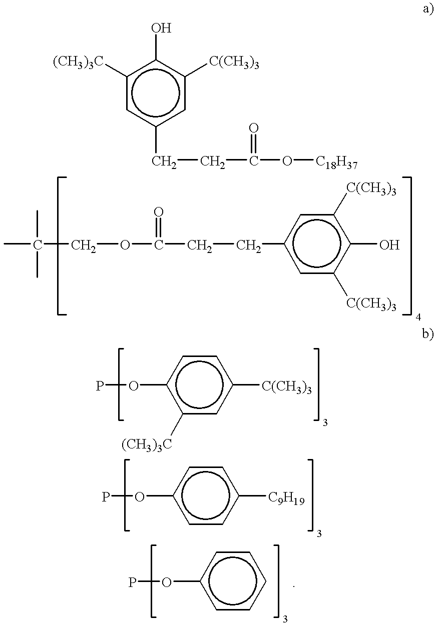

7. A stabilized styrene copolymer made of vinylaromatic monomers and of comonomers, prepared by the process as claimed in claim 1.

8. A stabilized styrene copolymer as claimed in claim 1, additionally comprising stabilizers to counter the action of light.

9. A molding, a film, a fiber or a foam comprising a stabilized styrene copolymer, prepared as claimed in claim 1.
